(19) United States
(12) Patent Application Publication
(10) Pub. No.: US 2014/0244798 A1
(43) Pub. Date: Aug. 28, 2014

(54) TCP-Based Weighted Fair Video Delivery

(71) Applicant: CISCO TECHNOLOGY, INC., San Jose, CA (US)

(72) Inventors: Mythili Suryanarayana Prabhu, San Jose, CA (US); Xiaoqing Zhu, Austin, TX (US); Rong Pan, Saratoga, CA (US); Hao Hu, San Jose, CA (US)

(73) Assignee: CISCO TECHNOLOGY, INC., San Jose, CA (US)

(21) Appl. No.: 13/778,350

(22) Filed: Feb. 27, 2013

(51) Int. Cl. H04L 29/06

(52) U.S. Cl. CPC H04L 65/608
USPC 709/219

(57) ABSTRACT

Weighted fair sharing of video bandwidth may be provided, for example, over TCP. First, a number of connections with a receiver may be opened. The number of active connections may be proportional to a weighting parameter associated with a stream. Next, the stream may be transmitted over the number of active connections and feedback information may be obtained corresponding to the stream received at the receiver. A quality adaptation may then be made based on the obtained feedback. The process may be repeated over time with the number of active connections changing along with the weighting parameters.

### BACKGROUND

The Transmission Control Protocol (TCP) is one of the core protocols of the Internet protocol suite. TCP is one of the two original components of the suite, complementing the Internet Protocol (IP); consequently, the entire suite is commonly referred to as TCP/IP. TCP provides reliable, ordered delivery of a stream of octets from a program on one computer to another program on another computer. TCP is the protocol used by major Internet applications such as the World Wide Web, email, remote administration, and file transfer.

### BRIEF DESCRIPTION OF THE DRAWINGS

The accompanying drawings, which are incorporated in and constitute a part of this disclosure, illustrate various embodiments of the present disclosure. In the

### DRAWINGS

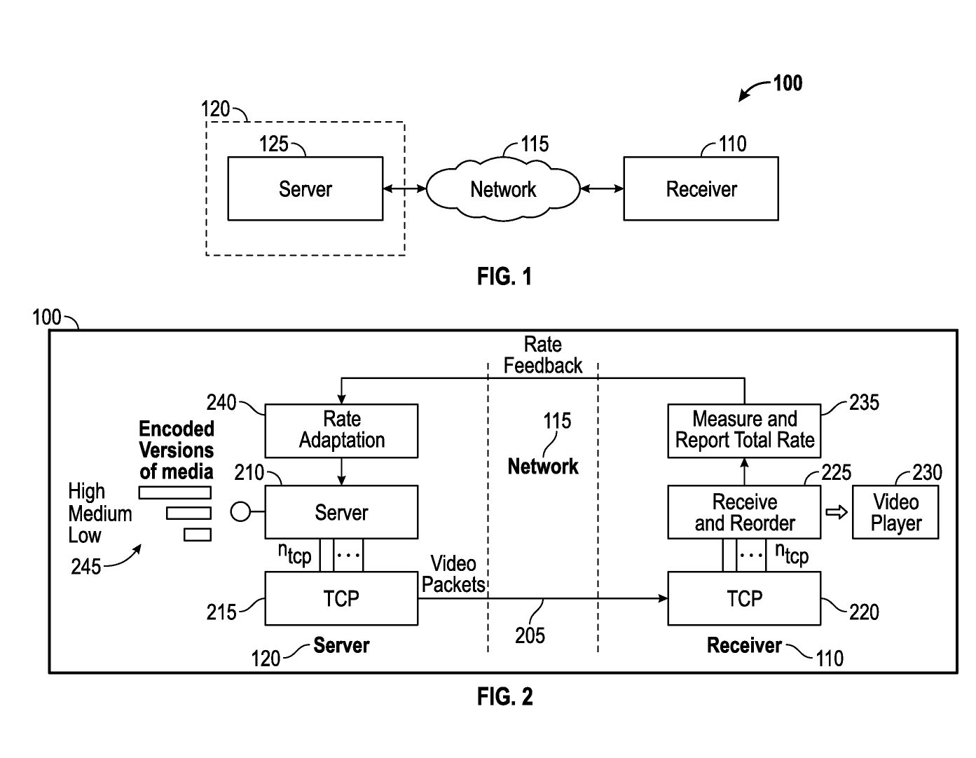

FIG. 1 illustrates an operating environment for video delivery;

FIG. 2 is a block diagram of a method;

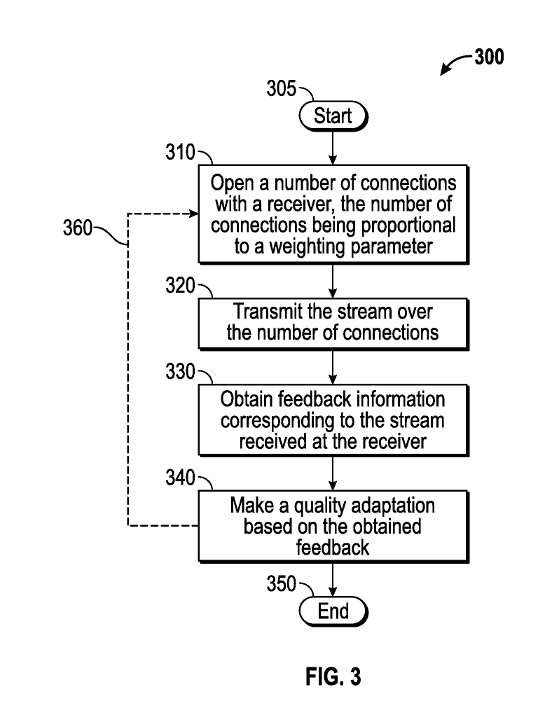

FIG. 3 is a flow chart of a method for providing fair video delivery;

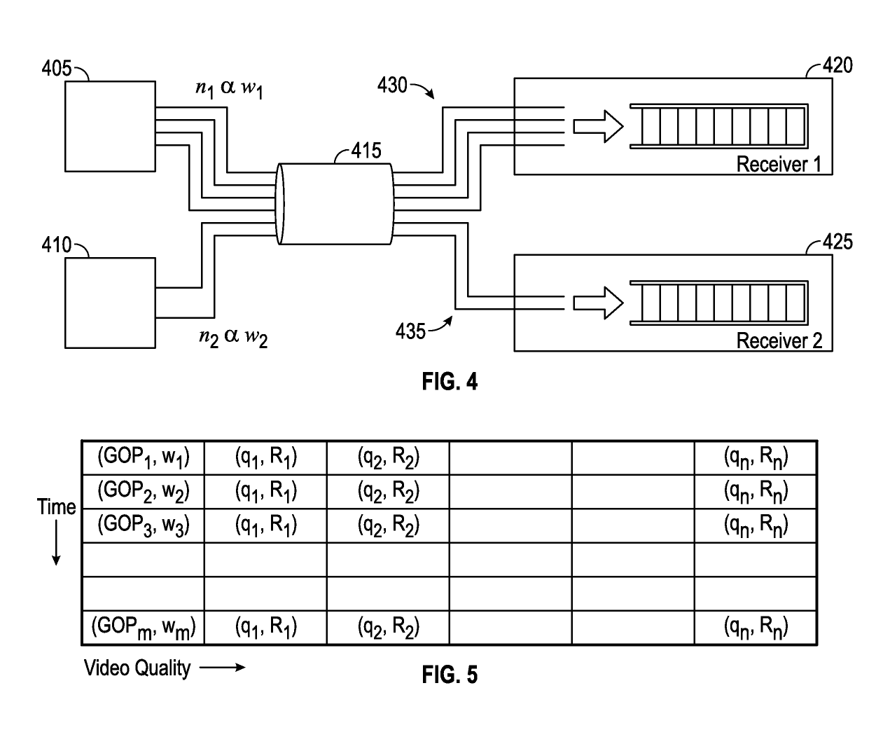

FIG. 4 illustrates weighted rate allocation;

FIG. 5 illustrates a metadata format;

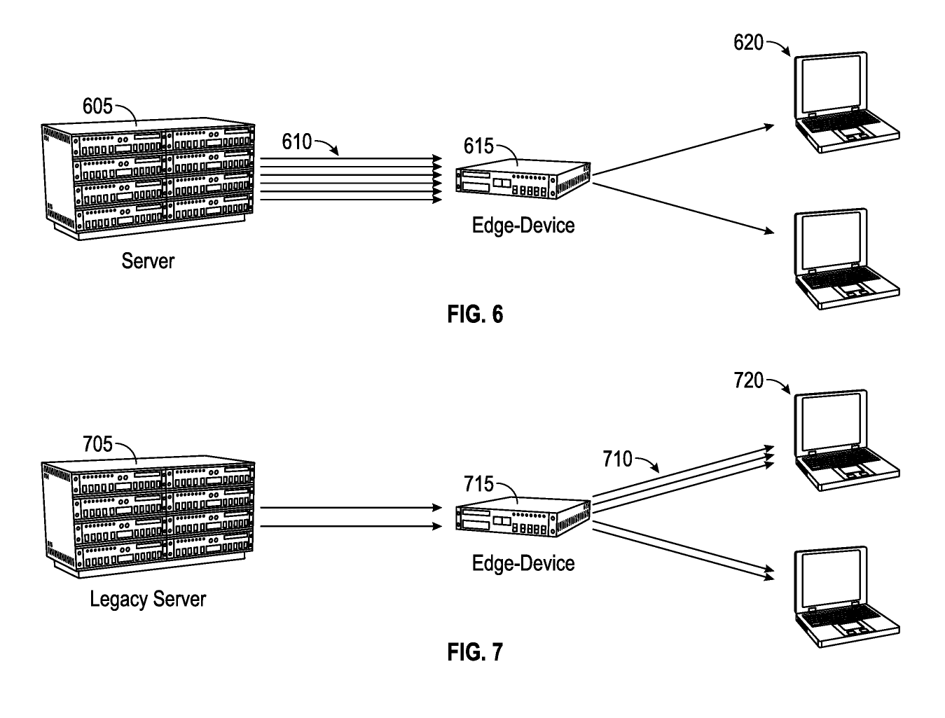

FIG. 6 is a block diagram of connections established between a server and an edge device;

FIG. 7 is a block diagram of connections established between an edge device and receivers;

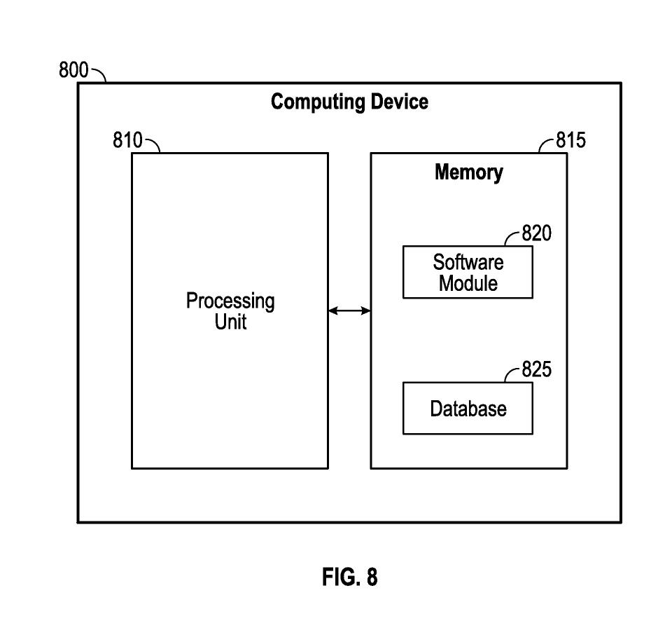

FIG. 8 is a block diagram of a computing device; and

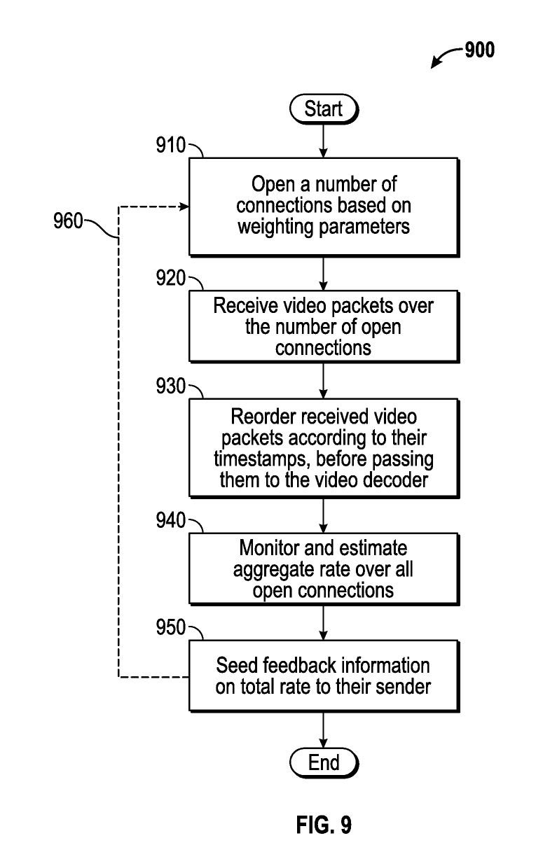

FIG. 9 is a flow chart of a method for providing fair video delivery.

### DETAILED DESCRIPTION

### Overview

Weighed fair sharing of video bandwidth may be provided, for example, over TCP. First, a number of connections with a receiver may be opened. The number of active connections may be proportional to a weighting parameter associated with a stream. Next, the stream may be transmitted over the number of active connections and feedback information may be obtained corresponding to the stream received at the receiver. A quality adaptation may then be made based on the obtained feedback.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Transmission Control Protocol (TCP) is a reliable form of transport and is free from network address translation (NAT) and firewall issues unlike User Datagram Protocol (UDP). Consequently, there has been an increasing desire to stream video over TCP. Many conventional Hypertext Transfer Protocol (HTTP) streaming systems are built upon TCP as the underlying transport protocol. Consistent with embodiments of the disclosure, weighted fair bandwidth sharing may be provided for video delivery over multiple TCP connections.

Embodiments of the disclosure support weighted fair bandwidth allocation for competing video streams over a bottleneck link. A server may open multiple TCP connections to stream a video. The number of active connections may be proportional to a weighting parameter associated for each stream. The operation of TCP congestion control may ensure that the bandwidth allocated to the video streams will eventually be proportional to their respective weighting factors. Embodiments of the disclosure may also accommodate time-varying choices of weighting parameters, by dynamically adjusting the number of active TCP connections periodically.

The weighting parameters of video streams can be determined by several factors. These factors may include, but are not limited to, video content complexity, relative importance or service priority of each stream/user, resolution size of a receiver display. Moreover, the weight of each stream may be derived from its rate-distortion model parameter.

FIG. 1 is a block diagram of an operating environment 100. As shown in FIG. 1, environment 100 may include a receiver 110, a network 115, and a content delivery system (CDS) 120. CDS 120 may comprise a server 125 capable of providing content to client device 110 over network 115. Content, for example, may comprise digital programs such as videos, television programs, movies, video on demand, unicast, and multicast broadcasts. The aforementioned are examples and the content may comprise other digital content forms.

The content may be communicated over network 115. Network 115 may be compatible with various communication protocols used to communicate the content. For example, server 125 may communicate with receiver 110 over network 115 using a datagram protocol (UDP) or other protocol typically used to communicate multicast transmissions over IP or non-IP networks such as QAM based content delivery. For various other transmissions, such as unicast transmissions, server 125 may communicate with receiver 110 over network 115 using Transmission Control Protocol/Internet Protocol (TCP/IP).

Consistent with embodiments of the disclosure, receiver 110 may be configured to request, receive, buffer, playback, and store, for example, content, which may be embodied in IP video packets or other data packets received either directly or indirectly from CDS 120. Server 125 may be, but is not limited to, a Wi-Fi access point, a cellular base station, a switch servicing multiple clients in a vicinity, a tablet device, a mobile device, a mobile phone, a smart phone, a telephone, a remote control device, a set-top box, a digital video recorder, a cable modem, a personal computer, a network computer, a mainframe, a router, other similar microcomputer-based devices, or any other computing device capable of communicating with CDS 120 over network 115.

FIG. 2 shows operating environment 100 in more detail. As shown in FIG. 2, server 120 may transmit a stream 205 to receiver 110 over network 115. Server 120 may include a server module 210 that may establish stream 205 (e.g., comprising a number of connections) using a server TCP module 215. A receiver TCP module 220 may receive stream 205 and provide it to a receive and reorder module 225. Receive and reorder module 225 may prepare data received from stream 205 to be displayed on a display device by video player 230. Receive and reorder module 225 may also report the rate at which data from stream 205 was received at receiver 110 to a measure and report total rate mode 235. Rate feedback may be sent from measure and report total rate mode 235 over network 115 to a rate adaptation module 240 in server 120. Based on the rate feedback, rate adaptation module 240 may determine if a quality adaptation may be needed. If so, rate adaptation module 240 may signal to server module 210 to switch between multiple encoded versions of a video 245. As an alternative, rate adaptation module 240 may be located in receiver 110.

FIG. 3 is a flow chart setting forth the general stages involved in a method 300 consistent with an embodiment of the disclosure for providing weighted fair video delivery. Method 300 may be implemented using server 125 and/or receiver 110 as described in more detail above and below. Ways to implement the stages of method 300 will be described in greater detail below.

Method 300 may begin at starting block 305 and proceed to stage 310 where server 125 may open a number of connections with receiver 110. The number of active connections may be proportional to a weighting parameter associated with stream 205. For example, server 120 may provide content to receiver 110 through stream 205. At the beginning of a session providing the content, a maximum number of TCP connections may be established with receiver 110. A number of active connections n_{tcp} may be proportional to the weight of the video, w_{video} (i.e. n_{tcp} α w_{video}) While server 120 may continuously chooses the number of active TCP connections for video stream 205, it may depend on the underlying TCP congestion control mechanism to converge to a weighted-fair proportion of the total available bottleneck link bandwidth.

As stated above, the weighting parameters of video streams may be determined by several factors. These factors may include, but are not limited to, video content complexity, relative importance or service priority of each stream/user, resolution size of a receiver display. For example, the complexity of a “talking head” news program may be less than the complexity of a fast moving sports program. Moreover, the weight of each stream may be derived from its rate-distortion model parameter.

FIG. 4. Illustrates the weighting for two streams with different content. A first stream 405 may correspond to a sports program and a second stream 410 may correspond to a news program. Both steams (first stream 405 and second stream 410) may be sent through a bottleneck link 415 respectively to a first receiver 420 and a second receiver 425. Because first stream 405 may correspond to a sports program that may require more bandwidth, it may receive a higher weight (w₁) than second stream 410 that may correspond to a news program. Second stream 410 may receive a weight (w₂) that is lower than w₁. The rate is given by the ratio of their respective weights w₁/w₂ thus ensuring weighted fairness. Consequently, a first number of connections 430 (i.e., n₁) for first stream 405 may include more connections than a second number of connections 435 (i.e., n₂) for second stream 410. Notwithstanding, the number of connections may be chosen such that n₁/n₂=w₁/w₂.

From stage 310, where server 125 opens the number of connections with receiver 110, method 300 may advance to stage 320 where server 125 may transmit stream 205 over the number of active connections. For example, server 120 may maintain multiple encoded versions of video 245. Content from one of multiple encoded versions of video 245 may be packetized and striped over the number of active connections. The packets may be transmitted on active TCP sockets corresponding to the number of connections in a round-robin fashion. The multiple TCP connections may be used as a way to provide bandwidth in a weighed fair manner for competing streams.

Once computing server 125 transmits stream 205 over the number of connections in stage 320, method 300 may continue to stage 330 where server 125 may obtain feedback information corresponding to stream 205 received at receiver 110. For example, server 125 may use the periodic feedback from receiver 110 about the total rate of stream 205 to make quality adaptation decisions. To obtain this feedback information for server 125, receiver 110 may scan through the active TCP active connections (i.e., n_{tcp}) to receive all video packets. In addition to this, receiver 110 may calculate the total rate of the streamed content over all the number of active connections. This feedback information may be fed back periodically to server 120 over network 115.

After server 125 obtains feedback information in stage 330, method 300 may proceed to stage 340 where server 125 may make a quality adaptation based on the obtained feedback. For example, server 120 my use the periodic feedback (e.g., feedback information) from receiver 110 about the total rate of stream 205 to make quality adaptation decisions. Quality adaptation may comprise switching between multiple encoded versions of a video 245, for example, at Group of Picture (GOP) boundaries to closely match the actual available rate. The switching may be done in small, gradual steps to provide smooth transitions of visual quality for the viewers. For example, if the current version being used was a high quality version and the feedback information indicated that the rate of stream 205 was slower than a certain threshold, server 120 may switch from the high quality version to the medium quality version. Similarly, if the current version being used was a low quality version and the feedback information indicated that the rate of stream 205 was faster than a certain threshold, server 120 may switch from the low quality version to the medium quality version. In other words, server 120 may switch first from the high quality version to the medium quality version, and then to low quality version. This transition may also occur in reverse order, i.e., low to medium, then to high.

Consistent with embodiments of the disclosure, receiver-based rate adaptation may be provided. For example, receiver 110 can observe the aggregate rate available to a given video stream (e.g., stream 205.) In the scheme described above, receiver 110 may relay back this information to server 120. Instead, in the receiver-based rate adaptation, rate adaptation module 240 may be moved to receiver 110. In this case, receiver 110 may need metadata information about stream 205 so that it can periodically send out requests to server 120 to switch to a particular encoded version (e.g., between multiple encoded versions of a video 245.) This may add a small overhead of transferring the aforementioned metadata to receiver 110, but in this embodiment, rate adaptation module 240 may be moved closer to receiver 110. FIG. 5 shows an example format of the aforementioned metadata that may be transferred to receiver 110. Once server 125 makes the quality adaptation in stage 340, method 300 may then end at stage 350. Method 300 may be repeated (e.g., loop 360) any number of times to provide weighted fair video delivery as the sender may update the number of TCP connections periodically over time.

Embodiments of the disclosure may include edge-based rate adaptation as illustrated in FIG. 6. In typical enterprise networks, a bottleneck resource may reside at an aggregate access link of each office location. In such a scenario, a server 605 can stream requested media (e.g., content) over multiple TCP active connections 610 to an edge-device 615. Edge-device 615 may function as a proxy by reordering received video packets over multiple TCP active connections 610, and relaying them to clients 620. This configuration may not require any changes at the receiver (e.g., clients 620), hence it may allow for the use of legacy clients.

Alternatively, in video streaming, for example, over cellular networks, the bottleneck resource may be between the edge of the network and the receiver as shown in FIG. 7. A server 705 can stream requested media (e.g., content) at the highest encoded quality, for example. An edge-device 715 can closely monitor network conditions as it may be in physical proximity to receivers 720. Hence, the rate adaptation module may be located in edge-device 715 and server 705 may only need to host the video content at the highest quality level. As multiple TCP connections 710 are established between edge-device 715 and clients 720, the competing video streams may share last-hop bottleneck bandwidth in a weighted fair manner consistent with embodiments of the disclosure.

Embodiments of the disclosure may allow weighted fair allocation of the available bandwidth for video streams sharing a bottleneck link. As stated above, the weight parameter can be determined by a broad range of factors, such as video characteristics of the streamed media, receiver display size, and relative priority of each stream. The streamed video may change dynamically based on the changing bandwidth conditions. Also, since video content could be varying in complexity, the scheme allows for switching between various versions of the video content periodically. Embodiments of the disclosure may be implemented readily, as it may not require any changes in the underlying network protocol stacks. The end points may rely on the existing TCP protocol to achieve rate adaptation. Hence, a stream may attain rates dictated by TCP and consequently, the streams may achieve rates comparable to TCP flows and coexist fairly.

The edge-based rate adaptation may offer further advantages. The edge-device may act as a proxy. If the bottleneck is between the edge and the clients, it can provide weighted-fair allocation to the streams by leveraging on the multiple active TCP connections. It can also monitor and adapt to available bandwidth if the bottleneck is between the server and edge of the network. It can take on all the receiver computation complexity and allow thin clients to benefit from the scheme.

FIG. 8 shows a computing device 800. As shown in FIG. 8, computing device 800 may include a processing unit 810 and a memory unit 815. Memory unit 815 may include a software module 820 and a database 825. While executing on processing unit 810, software module 820 may perform processes for providing fair video delivery, including for example, any one or more of the stages from method 300 described above with respect to FIG. 3. Computing device 800, for example, may provide an operating environment for receiver 110 or server 125. It may also serve as the video server or receiver proxy on the edge device shown in FIG. 6 and FIG. 7. Receiver 110 or server 125 may operate in other environments and are not limited to computing device 800.

Computing device 800 (“the processor”) may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, or other similar microcomputer-based device. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand held computer, a conventional telephone, or a Wireless Fidelity (Wi-Fi) access point. The aforementioned systems and devices are examples and the processor may comprise other systems or devices.

FIG. 9 is a flow chart setting forth the general stages involved in a method 900 consistent with an embodiment of the invention for providing control from the perspective of receiver 110. Method 900 may be implemented using receiver 110 as described in more detail above with respect to FIG. 2. Ways to implement the stages of method 900 will be described in greater detail below.

Receiver 110 may open a number of connections based on weighting parameters. (Stage 910.) Next, receiver 110 may receive video packets over the number of open connections from server 120. (Stage 920.) Receive and reorder module 225 may reorder received video packets according to their timestamps before passing them to the video player 230. (Stage 930.) Measure and report total rate mode 235 may monitor and estimate aggregate rate over all open connections. (Stage 940.) Measure and report total rate mode 235 may seed feedback information on total rate to server 120. (Stage 950.) Method 900 may be repeated (e.g., loop 960) any number of times to receive weighted fair video delivery as server 120 may update the number of TCP connections periodically over time.

An embodiment consistent with the disclosure may comprise a system for providing client control. The system may comprise a memory storage and a processing unit coupled to the memory storage. The processing unit may be operative to open a number of connections with a receiver. The number of active connections may be proportional to a weighting parameter associated with a stream. In addition, the processing unit may be operative to transmit the stream over the number of active connections and to obtain feedback information corresponding to the stream received at the receiver. Moreover, the processing unit may be operative to make a quality adaptation based on the obtained feedback.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
opening a number of connections with a receiver, the number of active connections being proportional to a weighting parameter associated with a stream;
transmitting the stream over the number of active connections;
obtaining feedback information corresponding to the stream received at the receiver; and
making a quality adaptation based on the obtained feedback.

2. The method of claim 1, wherein opening the number of connections comprises opening the number of active connections wherein the weighting parameter is based on a complexity of video content associated with the stream.

3. The method of claim 1, wherein opening the number of connections comprises opening the number of active connections wherein the weighting parameter is based on a service priority of video content associated with the stream.

4. The method of claim 1, wherein opening the number of connections comprises opening the number of active connections wherein the weighting parameter is based on a service priority of a user associated with the stream.

5. The method of claim 1, wherein opening the number of connections comprises opening the number of active connections wherein the weighting parameter is based on a resolution size of a display.

6. The method of claim 1, wherein opening the number of connections comprises opening the number of active connections wherein the weighting parameter is based on a rate-distortion model parameter of the stream.

7. The method of claim 1, wherein transmitting the stream over the number of connections comprises striping data packets corresponding the stream over the number of active connections.

8. The method of claim 1, wherein obtaining the feedback information from the receiver comprises obtaining the feedback information corresponding to a rate of the stream received at the receiver.

9. The method of claim 1, wherein making the quality adaptation comprises switching the stream being transmitted between different encoded versions based upon the received feedback information.

10. The method of claim 1, wherein making the quality adaptation comprises switching the stream being transmitted at group of picture (GOP) boundaries between different encoded versions based upon the received feedback information.

11. The method of claim 1, wherein opening the number of connections comprises opening the number of connections wherein the receiver comprises an edge-device.

12. The method of claim 1, wherein opening the number of connections comprises opening the number of connections by an edge-device.

13. An apparatus comprising:
a memory storage; and
a processing unit coupled to the memory storage, wherein the processing unit is operative to:
open a number of connections with a receiver, the number of active connections being proportional to a weighting parameter associated with a stream;
transmit the stream over the number of active connections to the receiver;
receive, from the receiver, feedback information corresponding to the stream received at the receiver; and
make a quality adaptation based on the received feedback by switching the stream being transmitted between different encoded versions based upon the received feedback information.

14. The apparatus of claim 13, wherein the processing unit being operative to open the number of connections comprises the processing unit being operative to open the number of active connections wherein the weighting parameter is based on a complexity of video content associated with the stream.

15. The apparatus of claim 13, wherein the processing unit being operative to open the number of connections comprises the processing unit being operative to open the number of active connections wherein the weighting parameter is based on a service priority of video content associated with the stream.

16. The apparatus of claim 13, wherein the processing unit being operative to open the number of connections comprises the processing unit being operative to open the number of active connections wherein the weighting parameter is based on a service priority of a user associated with the stream.

17. The apparatus of claim 13, wherein the processing unit being operative to open the number of connections comprises the processing unit being operative to open the number of active connections wherein the weighting parameter is based on a resolution size of a display.

18. The apparatus of claim 13, wherein the processing unit being operative to open the number of connections comprises the processing unit being operative to open the number of active connections wherein the weighting parameter is based on a rate-distortion model parameter of the stream.

19. The apparatus of claim 13, wherein the processing unit being operative to transmit the stream over the number of active connections comprises the processing unit being operative to stripe data packets corresponding to the stream over the number of active connections.

20. The apparatus of claim 13, wherein the processing unit being operative to receive the feedback information from the receiver comprises the processing unit being operative to receive the feedback information corresponding to a rate of the stream received at the receiver.

21. The apparatus of claim 13, wherein the processing unit being operative to make the quality adaptation comprises the processing unit being operative to switch the stream being transmitted at group of picture (GOP) boundaries between different encoded versions based upon the received feedback information.

22. A method comprising:
receiving a stream over a number of connections, the number of active connections being proportional to a weighting parameter associated with the stream;
calculating feedback information corresponding to the received stream; and
sending quality adaptation information based on the calculated feedback.

23. The method of claim 22, wherein receiving the number of connections comprises receiving the number of active connections wherein the weighting parameter is based on at least one of the following: a complexity of video content associated with the stream, a service priority of video content associated with the stream, a service priority of a user associated with the stream, a resolution size of a display, and a rate-distortion model parameter of the stream.

24. The method of claim 22, wherein receiving the stream over the number of connection comprises receiving data packets corresponding the stream striped over the number of active connections.

25. The method of claim 22, wherein calculating the feedback information comprises calculating the feedback information comprising a rate of the received stream.

26. The method of claim 22, wherein sending quality adaptation information comprises sending quality adaptation information configured to switch the stream between different encoded versions.

27. An apparatus comprising:
a memory storage; and
a processing unit coupled to the memory storage, wherein the processing unit is operative to:
receive a stream over a number of connections, the number of active connections being proportional to a weighting parameter associated with the stream;
calculate feedback information corresponding to the received stream; and
send quality adaptation information based on the calculated feedback.

28. The apparatus of claim 27, wherein the processing unit being operative to receive the number of connections comprises the processing unit being operative to receive the number of active connections wherein the weighting parameter is based on at least one of the following: a complexity of video content associated with the stream, a service priority of video content associated with the stream, a service priority of a user associated with the stream, a resolution size of a display, and a rate-distortion model parameter of the stream.

29. The apparatus of claim 27, wherein the processing unit being operative to receive the stream over the number of connection comprises the processing unit being operative to receive data packets corresponding to the stream striped over the number of active connections.

30. The apparatus of claim 27, wherein the processing unit being operative to send quality adaptation information comprises the processing unit being operative to send quality adaptation information configured to switch the stream between different encoded versions.
